(19) United States
(12) Patent Application Publication
(10) Pub. No.: US 2026/0016418 A1
(43) Pub. Date: Jan. 15, 2026

(54) IN DEPTH POLYTYPE IDENTIFICATION IN SILICON CARBIDE

(71) Applicant: GlobalWafers Co., Ltd., Hsinchu (TW)

(72) Inventors: Elisa Calà, Tagliolo Monferrato (IT); Simone Cerruti, San Marzano Oliveto (IT); Giorgio Gatti, Borghetto Santo Spirito (IT); Luciano Ramello, Torina (IT); Maria Cristina Sanna, Novara (IT); Marco Maffè, Novara (IT); Wen Ching Hsu, Hsinchu (TW); Man Hsuan Lin, Hsinchu (TW)

(21) Appl. No.: 19/261,020

(22) Filed: Jul. 7, 2025

Related U.S. Application Data
(60) Provisional application No. 63/669,651, filed on Jul. 10, 2024.
(60) Provisional application No. 63/750,592, filed on Jan. 28, 2025.

(51) Int. Cl. G01N 21/65; C01B 32/956

(52) U.S. Cl. CPC G01N 21/65; C01B 32/956; C01P 2002/82; C01P 2002/84; G01N 2201/063

(57) ABSTRACT

Methods for determining polytypes of a silicon-carbide structure are disclosed. A Raman microspectrometer is powered to direct a laser at the front surface of the silicon-carbide structure. The depth of focus of the Raman microspectrometer is modulated to generate a plurality of Raman spectra at different depths below the surface of the structure. The Raman spectra are used to determine the SiC polytype.

### CROSS-REFERENCE TO RELATED APPLICATIONS

This application claims the benefit of U.S. Provisional Patent Application No. 63/669,651, filed Jul. 10, 2024, and claims the benefit of U.S. Provisional Patent Application No. 63/750,592, filed Jan. 28, 2025. Both applications are incorporated herein by reference in their entirety.

### TECHNICAL FIELD

The field of the disclosure relates to analysis of silicon carbide structures and, in particular determination of polytypes in such structures along the X, Y and Z axes of the structure.

### BACKGROUND

Silicon carbide wafers are used in a number of electronic devices including radiofrequency devices and 5G electronics. Silicon carbide is typically grown in one of a number of polytypes in which silicon carbide may exit such as 4H—SiC or 6H—SiC. Silicon carbide may include superficial defects which affect the performance of the resulting device. Due to the similarity between polytypes, it is difficult to detect defects in silicon carbide material.

A need exists for methods to detect different polytypes of silicon carbide in silicon carbide material.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a method for determining SiC polytypes of a silicon-carbide wafer structure. The structure has a front surface, a rear surface and a surface region disposed between the front surface and rear surface. A Raman microspectrometer is powered to direct a laser at the front surface of the silicon-carbide wafer structure. The depth of focus of the Raman microspectrometer is modulated to generate a plurality of Raman spectra at different depths below the surface of the wafer. The SiC polytype is determined at the depth based on the Raman spectra.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a cross-section view of a silicon carbide structure;

FIG. 2 is a schematic of an example Raman microspectrometer;

FIG. 3 shows Raman spectra generated from a silicon carbide wafer;

FIGS. 4-6 show Raman spectra of a silicon carbide structure where a Raman spectrometer was modulated by changing magnification and penetration depth to visualize polytypes along the Z-axis;

FIG. 7 is a silicon carbide wafer analyzed according to Example 1;

FIG. 8 shows 3D Raman spectra taken in Zone B of the silicon carbide wafer of FIG. 7;

FIG. 9 is a silicon carbide wafer visually reporting extra-phases and to different analysis zones;

FIG. 10 is Raman spectra in the 700-1200 cm-1 region of the polytype 4H, 15R and 6H—SiC.

Corresponding reference characters indicate corresponding parts throughout the drawings.

### DETAILED DESCRIPTION

Provisions of the present disclosure relate to methods for determining SiC polytypes of a silicon-carbide structure. The present disclosure enables improvements in material quality by mapping areas where different polytypes are present and to map non-uniform polytype distribution across the wafers and in the bulk of the specimen itself. This analysis can be performed at each wafering step to help identify low quality boules.

Example structures which may be analyzed by the disclosed methods include single crystal or amorphous silicon carbide of different polytypes. Example structures include 4H—SiC majority polytype structures (i.e., a wafer that is predominantly 4H-type). The structure may be a wafer or wafer segment and may be at any stage of processing (including epitaxy). The analysis method is not diameter dependent and the analysis method may be adapted for the diameter of interest (e.g., 100 mm, 150 mm, 200 mm, 300 mm).

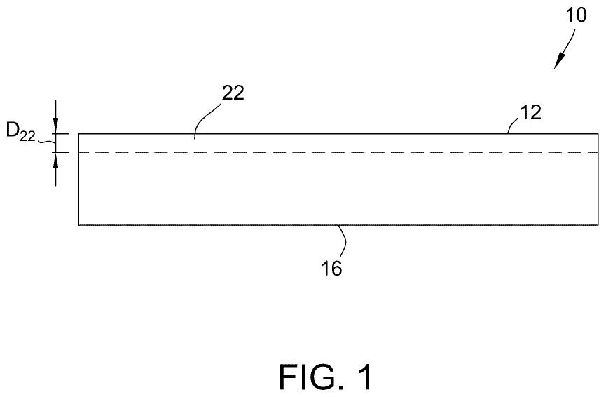

Referring now to FIG. 1, an example silicon-carbide structure 10 is shown. The structure 10 includes a front surface 12, a rear surface 16 and a surface region 22 disposed between the front surface 12 and the back surface 16. The surface region 22 extends from the front surface 12 to a depth D₂₂. The front surface 12 may have any surface texture after wafering such as a surface structure typical after cutting/slicing, grinding, polishing, etc.

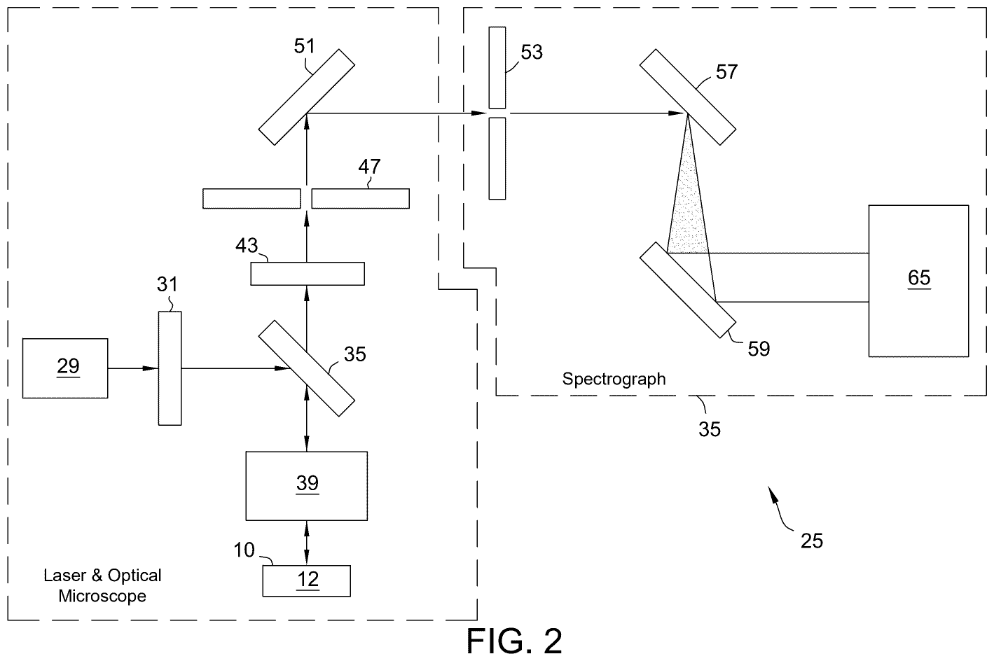

An example Raman microspectrometer for use in embodiments of the present disclosure is shown in FIG. 2. In a first step of embodiments of the present disclosure, the Raman microspectrometer 25 is powered to direct a laser 29 at the front surface 12 of the silicon carbide structure 10. The laser 29 of the Raman microspectrometer 25 directs light through a line filter 31 and to a beam splitter 35. Generally, any laser that is capable of generating scattered Raman light when directed to a sample may be used. In some embodiments, the laser 29 is an argon ion laser.

The wavelength of the laser may be selected to optimize the signal-to-noise ratio (see. e.g., Nakashimaet et al., Raman Characterization of Damaged Layers of 4H—SiC Induced by scratching, AIP Advances 6 (2016) and Fromm et al., Contribution of the Buffer Layer to the Raman Spectrum of Epitaxial Graphene on SiC (0001), New Journal of Physics 15 (2013), which are both incorporated herein by reference for all relevant and consistent purposes).

In some embodiments, the laser 29 is operated below maximum laser power to improve the signal-to-noise ratio. For example, the laser may be operated at less than 50% of a maximum laser power or, as in other embodiments, less than 40%, less than 20%, less than 15%, from 5% to 50% or from 5% to 20% of maximum laser power.

Light passes through the objective lens 39 of the optical microscope of the Raman microspectrometer 25. The optical lens 39 focuses the laser light onto the sample 10 and collects the scattered light from the sample 10. The numerical aperture (NA) of the objective lens 39 determines the diameter (D) of the focused laser beam on the sample surface by:

$$D = 1.22 * λ / N A \qquad ( Eq . 1 )$$

where λ is the wavelength of the laser. Numerical aperture (NA) for various objective magnification is shown in Table 1:

TABLE 1
Value of NA related objective magnification.

| Objective Magnification | NA |
|---|---|
| 100 | 0.90 |
| 80 | 0.75 |
| 50 | 0.50 |
| 20 | 0.40 |
| 10 | 0.25 |

As can be seen from Eq. 1, increasing the numerical aperture of the objective lens lowers the dimeter of the focused laser beam and improves spatial resolution.

Scattered light passes through the beam splitter 35 and passes through a filter 43. The filter 43 may be a notch filter or edge filter and filters out Rayleigh scattered light.

In the illustrated embodiment of the Raman spectrometer 25, light then passes through a confocal pinhole 47 that blocks out unfocused light. In other embodiments, the Raman microspectrometer is not confocal.

Light is reflected by mirror 51 and enters the spectrograph 35 by passing through an entrance slit 53. The spectrograph 35 separates the light spatially by mirrors 59 and diffraction grating 57. The light is then detected by a charge-coupled device (CCD) 65 such as a CCD camera.

The Raman microspectrometer 25 described above and shown in FIG. 2 is an example spectrometer and other spectrometers (e.g., having different or additional components) may be used without departing from the scope of the present disclosure. Raman microspectrometers are available commercially and include LabRam HR Evolution which is a microscopic confocal Raman spectrometer available from Hariba Ltd. (Kyoto, Japan).

In accordance with embodiments of the present disclosure, the depth of focus of the microspectrometer 25 is modulated to generate a plurality of Raman spectra at different depths below the surface of the sample 10 within the surface region 22. In some embodiments, the depth of focus is modulated by changing the magnification of the optical microscope by using different lenses 39 (e.g., with magnification and depth of analysis being inversely proportional). For example, a series of optical lens that increases magnification may be used to modulate the depth of focus (e.g., 5×, 10×, 20×, 50×, and 100× magnification lenses).

The depth of focus of the microspectrometer may alternatively be modulated by increasing the intensity of the laser.

The depth of focus may be modulated within the surface region 22 of the silicon carbide structure at, for example, magnifications between 10× and 100× and may extend to depths between 0.2 μm and 4 μm below the surface.

In some embodiments, the laser is directed at a plurality of sites on the front surface 12 of the silicon carbide structure 10. The depth of focus of the Raman microspectrometer is modulated at each site to generate a plurality of Raman spectra at different depths below the surface of the wafer at each site. This enables polytypes along the X, Y and Z axis to be identified. By modulating the depth of focus of the Raman microspectrometer 25 at a plurality of sites, a 3D Raman spectra map based on the plurality of Raman spectra may be formed (i.e., Micro Raman Mapping (“MRM”)).

After the Raman spectra are generated at a depth below the surface of the structure, the SiC polytype at the depth may be determined based on the Raman spectra. For example, the generated spectra may be compared to a library of Raman spectra that are associated with a polytypes of silicon carbide. For example, the Raman spectra may be generated by a processor and compared to a library of Raman spectra stored within computer memory. In other embodiments, the generated Raman spectra may be compared manually (e.g., by an operator) to stored Raman spectra (e.g., Raman spectra in published literature) to determine the polytype.

The library of Raman spectra may be prepared by generating Raman spectra for known polytypes of silicon carbide such as, for example, 6H, 12R, 15R, 3C, 2H, 4H, 8H (see, e.g., Nakashima et al., Raman Investigation of SiC Polytypes, Physica Status Solidi (a), vol. 162 (1997), pages 39-64, which is incorporated herein by reference for all relevant and consistent purposes).

Since the band gap energy of SiC electrons is larger than the energy of the laser (e.g., argon ion laser), the Raman measurement of a-SiC in the visible region is usually not disturbed by luminescence except for heavily doped samples. A visible laser (e.g., 532 nm) may be selected as the excitation laser for the Raman microspectroscopy process, possessing a photon energy (e.g., 2.33 eV) much lower than the band gap of 4H—SiC (3.3 eV).

Silicon carbide has relatively low absorption coefficients in the visible region and gives a large penetration depth for Raman probe lasers. It has been reported that penetration depth d is roughly evaluated by:

$$d = 1 / ( 2 a ) \qquad ( Eq . 2 )$$

where a is the absorption coefficient.

With the band gap of 4H—SiC being 3.3 eV, and according to reported absorption coefficients for high-quality samples, a typical value d=2 mm is obtained for visible lasers at wavelength 500 nm (2.5 eV in photon energy).

To ensure that the penetration depth of the excitation light is limited to the surface region, it has been suggested to gradually scale down the laser power. As the effective penetration depth of the excitation light decreases, the Raman signal will have a contribution that derives more from the surface region of the SiC wafer. Based on experimental results (Tseng et al., Using Visible Laser-Based Raman Spectroscopy to Identify the Surface Polarity of Silicon Carbide, The Journal of Physical Chemistry, vol. 120, 32, pages 18228-18234 (2016), which is incorporated herein by reference for all relevant and consistent purposes), the power of the incident light with an intensity of 0.12% was the threshold power of the excitation laser required to generate Raman signals. With this approach, the data reported for an intensity of 1 and 100% indicate a depth of 0.245 and 3.830 μm, respectively.

Based on this method of attenuation, a laser power of less than 50% of a maximum laser power or, as in other embodiments, less than 40%, less than 20%, less than 15% or from 5% to 50% or from 5% to 20% of maximum laser power, may be selected to obtain spectra with a good signal-to-noise ratio. In some embodiments, a laser power of about 10% of maximum laser power is used to obtain spectra with a good signal-to-noise ratio. In these embodiments, a signal-to-noise ratio appropriate to the numerical treatments that have been performed on the recorded data sets may be achieved.

During Raman microspectroscopy, when using an objective lens with a numerical aperture of NA, the diameter of the focused laser beam on a sample surface is given by Eq. 1 (above). For λ=532 nm and NA that is conventionally stated on the optical lens used, the diameter (D) of 0.9 mm is obtained. This implies that Raman spectra can be measured with a spatial resolution of mm or sub-mm scale. For the Raman microprobe measurement, the experimental geometry is limited to a backscattering geometry.

The methods of the present disclosure may be used to map an entire wafer (or sections thereof) or segments of a wafer or other SiC structure may be analyzed by the disclosed methods. The sample may be analyzed in a pattern with multiple points of the sample being analyzed.

Compared to conventional methods, the methods of the present disclosure for detecting polytypes in silicon carbide have several advantages. 3D Raman mapping provides a reliable metrology to evaluate SiC quality and to make estimation of doping concentration in the bulk without destructive material. This can lead to significant material cost savings compared to conventional techniques.

Raman microscopy enables punctual analysis (˜1 μm²) to detect the presence of surface and sub-surface defects in polished and epitaxial wafers. Determining the quantity and distribution of defects present in the surface region of the wafer furthers investigation of the causes of defect formation which may result in reduction or elimination of their formation.

Micro Raman Mapping is a relatively precise process and may be automated. Relatively large number of point analyses may be generated in the form of mapping in a given area of interest to examine portions of wafers in a regular, controlled and repeatable way.

The intensity of the Raman signal may be related to concentration, the position of the band structure, and the presence of functional groups. Raman shift may be correlated to defects correlated to mechanical parameters, such as stress, deformations, temperature variations or pressure. Peak amplitude at half heights may be correlated to the degree of crystallinity/defectivity, presence of doping.

Different batches of wafers and different points within the same batch may be monitored to check the extra and intra-batch quality, respectively. By selecting bands related to specific superficial defects, it is possible to obtain maps that explain the type of defects present, their number and location within the wafer. Through the use of multivariate analysis (e.g., Principal Component Analysis (PCA)) it is possible to select components containing useful information, and to visualize in readable format the formation of any groupings, clusters or trends. The specifications of the current raw material used (average value on replicates) may be evaluated with intra and extra-batch variability prior to proceeding to the next steps of processing. The disclosed methods may be used to analyze and modify various production steps and spectroscopic information may be correlated to mechanical information (e.g., stress tests) carried out along the production steps. It is possible to verify defect contributions and to assign one or more bands of the Raman spectrum to deficits of specific performance or characteristics such as mechanical stress, wafer thickness, etc.

### EXAMPLES

The processes of the present disclosure are further illustrated by the following Examples. These Examples should not be viewed in a limiting sense.

### Example 1: Polytype Detection

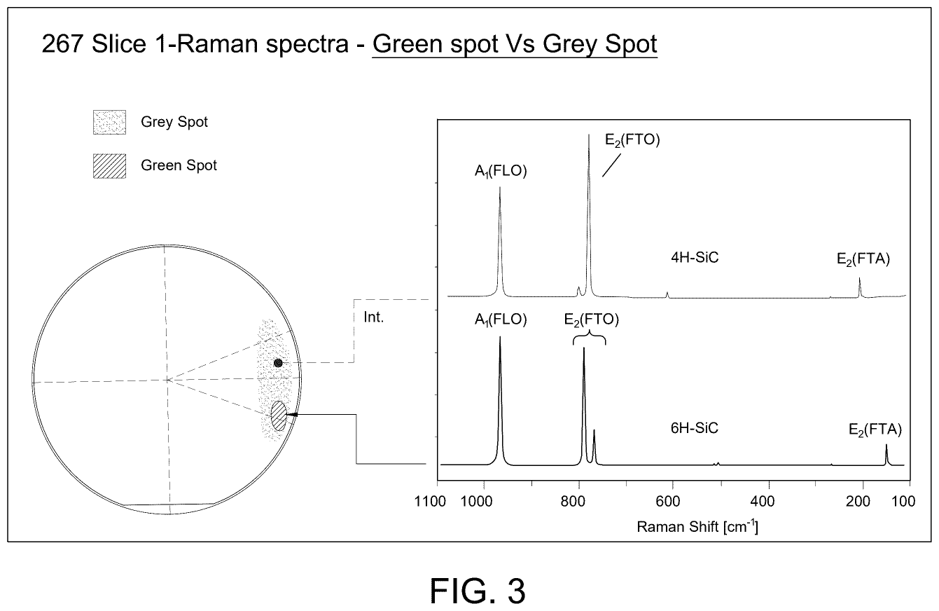

4H and 6H micro-Raman peaks (FIG. 3) were observed in a SiC wafer provided by GlobalWafers, Co., Ltd. (Hsinchu, TW).

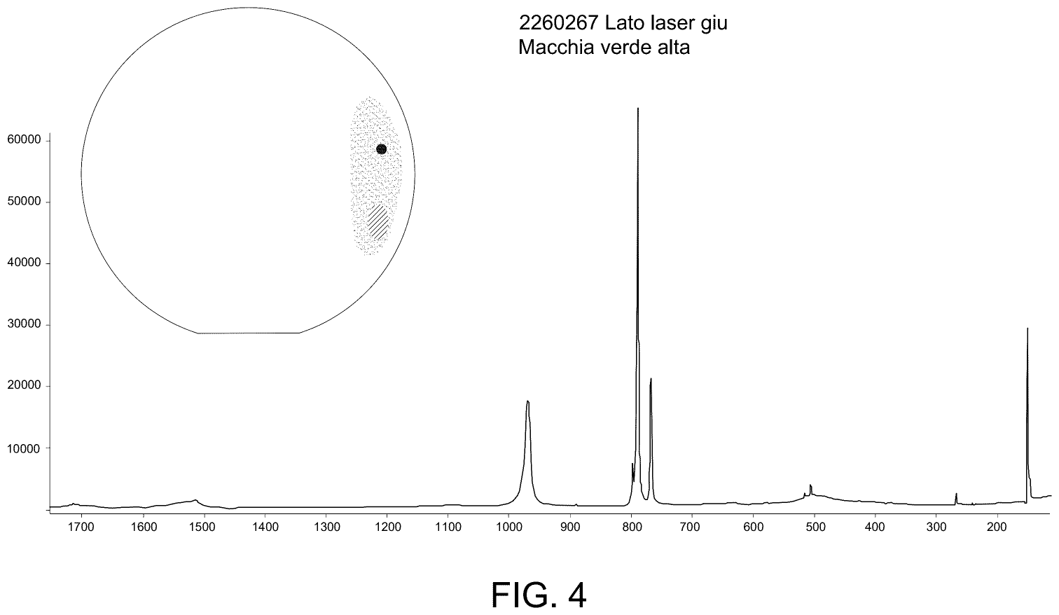

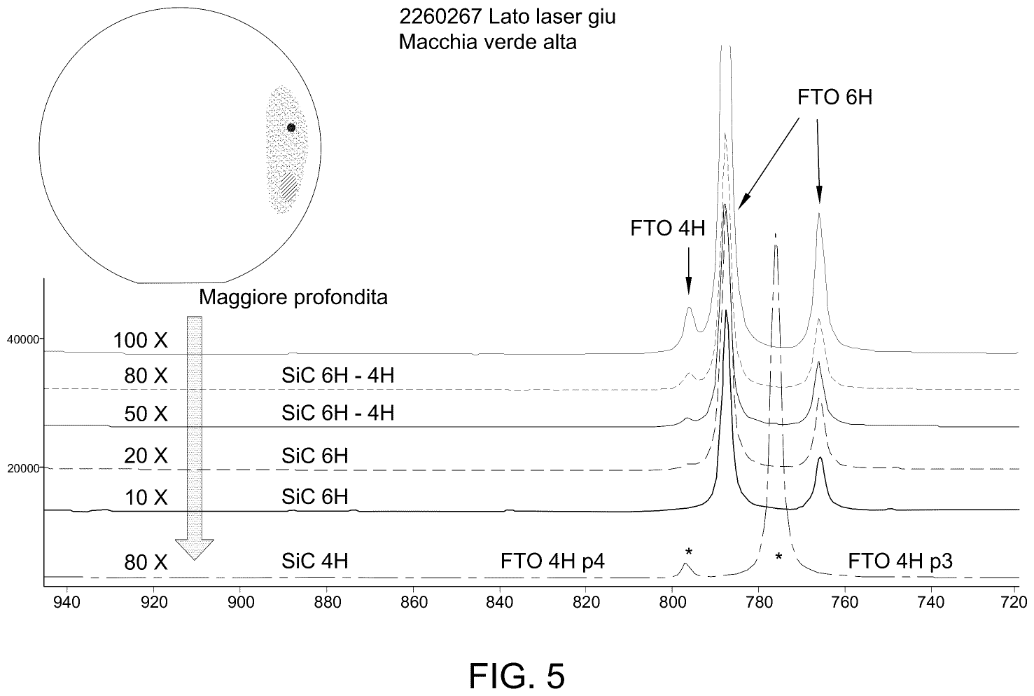

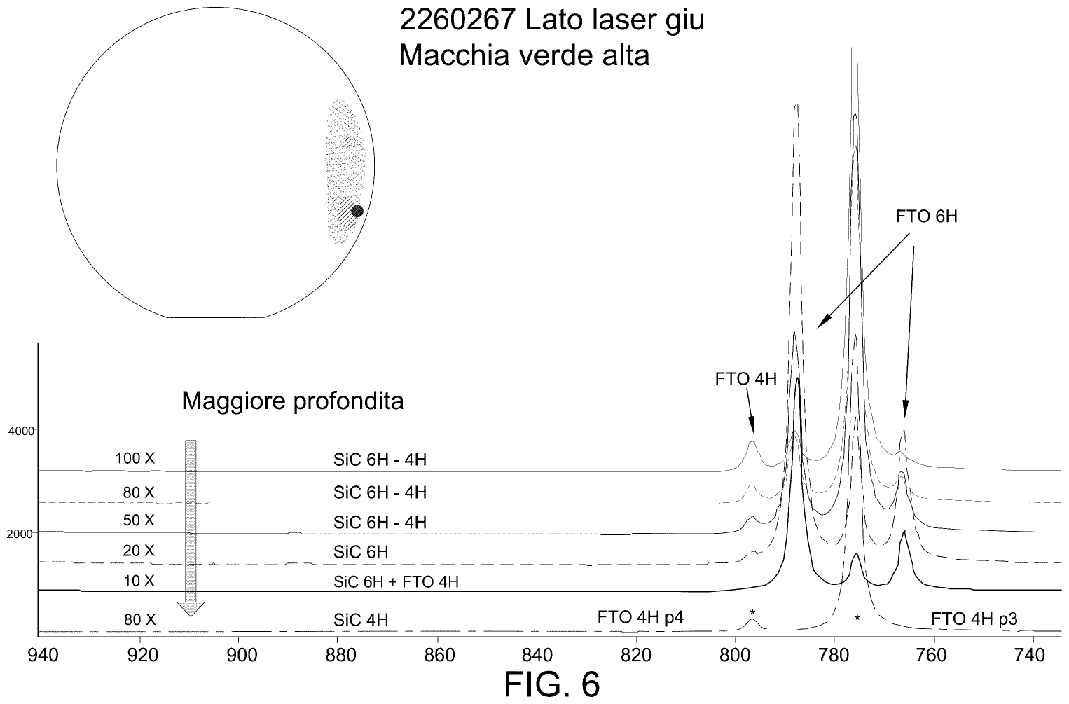

Differences in spectra between wafers measured with laser up or flipped with laser down were observed. To determine the effect, micro-Raman equipment was modulated by changing magnification to vary penetration depth in order to get all the polytypes across the Z-axis to a depth below the surface (FIGS. 4-6).

Samples were analyzed by 3D Raman microspectroscopy by modulating the micro-Raman depth of focus through magnification modulation and mapping the structure of the whole samples across X, Y and Z directions. The samples predominantly showed the presence of the 4H polytype, within a thickness of 0.4 μm. In a small number of wafers, the 6H polytype was detected in zones that appeared green (labeled as “Zone A” in the Figures.

Silicon carbide wafers having a 4H polytype (SiC—4H) were analyzed by a Raman microspectrometer by modulating the depth of focus of the microspectrometer (by changing the magnification) to generate Raman spectra at different depths below the surface of the wafer. The microspectrometer was a LabRam HR Evolution microscopic confocal Raman spectrometer from Horiba Ltd. (Kyoto, Japan). Micro-Raman spectroscopy was excited by a 3.3 mW, 532 nm (penetration depth: ˜2 mm) continuous-wave (CW) Nd:YAG laser. The laser beam was focused on a spot about 0.7 μm in diameter. The samples were placed on a XYZ stage with 1 μm spatial resolution.

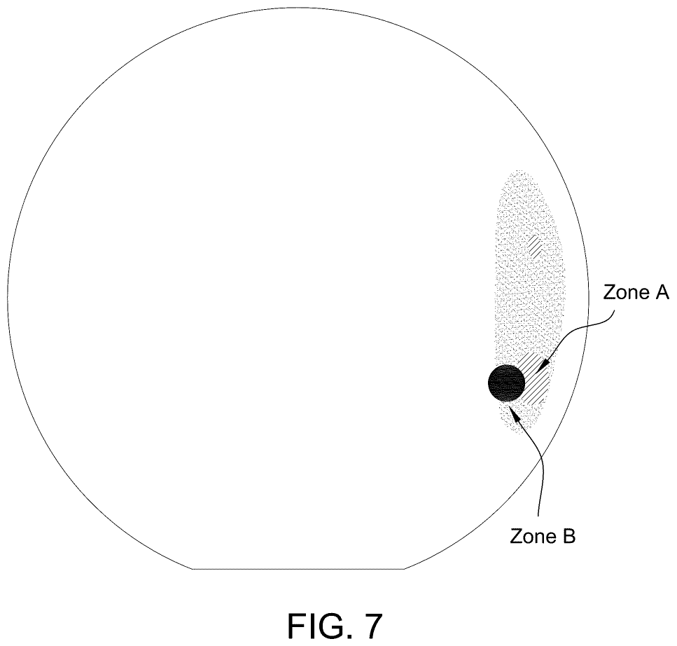

Referring now to FIG. 7, in a small number of wafers, the 6H polytype was detected in zones labeled as Zone A which, among different wafers, was both visible and invisible to the eye. In one instance, both the 6H polytype and 15R polytube were detected in the bulk layers (between 0.4 μm and 4 μm depth).

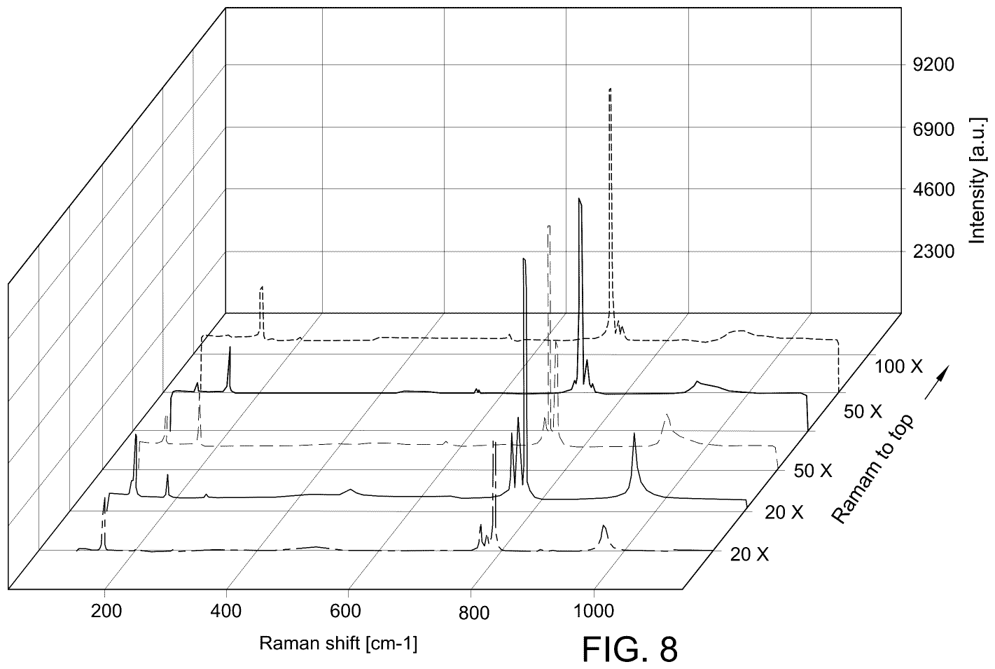

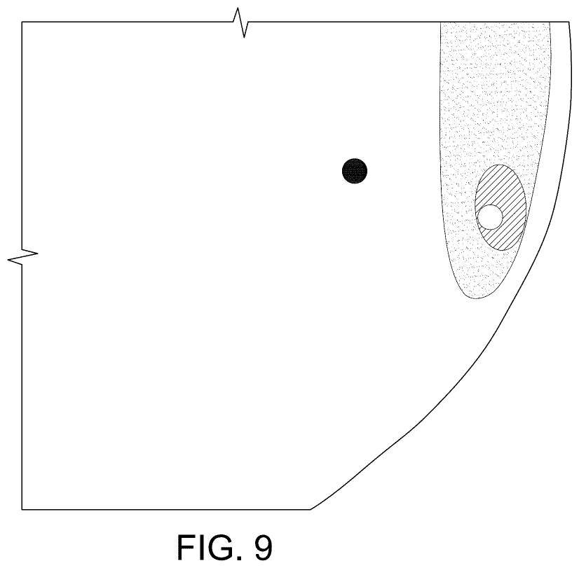

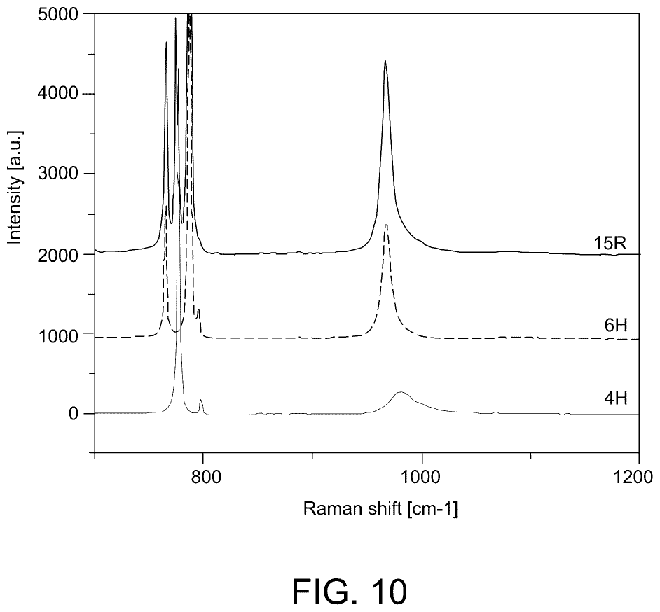

FIG. 8 shows the three-dimensional Raman spectra in Zone B. The three-dimensional spectra were generated going from (top to bottom) 100×, 80×, 50×, 20× and 10× magnification. In the region between 750-800 cm-1 typical of absorptions called Transverse Optic Mode (FTO-mode), spectra shows an alternation of the 4H, 6H and 12R polytypes, proceeding from the surface to a depth below the surface with the bands overlapping in this region. FIGS. 9-10 indicate the presence of an additional detected extra-polytype, the 15R polytype.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a,” “an,” “the,” and “said” are intended to mean that there are one or more of the elements. The terms “comprising,” “including,” “containing,” and “having” are intended to be inclusive and mean that there may be additional elements other than the listed elements. The use of terms indicating a particular orientation (e.g., “top,” “bottom,” “side,” etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A method for determining SiC polytypes of a silicon-carbide wafer structure, the structure having a front surface, a rear surface and a surface region disposed between the front surface and rear surface, the method comprising:
powering a Raman microspectrometer to direct a laser at the front surface of the silicon-carbide wafer structure;
modulating the depth of focus of the Raman microspectrometer to generate a plurality of Raman spectra at different depths below the surface of the wafer; and
determining the SiC polytype at the depth based on the Raman spectra.

2. The method as set forth in claim 1 further comprising forming a 3D Raman spectra map based on the plurality of Raman spectra.

3. The method as set forth in claim 1 wherein the surface region extends to a depth between 0.2 μm and 0.4 ρm.

4. The method as set forth in claim 1 wherein the Raman microspectrometer comprises an optical microscope and a Raman spectrometer, the depth of focus being modulated by changing the magnification of the optical microscope.

5. The method as set forth in claim 4 wherein the Raman microspectrometer comprises the laser, a spectrograph, and a charge coupled device for detecting light, the Raman microspectrometer being configured such that light from the laser is directed through the optical microscope toward the silicon-carbide structure.

6. The method as set forth in claim 1 further comprising directing a laser at a plurality of sites on the front surface of the silicon-carbide structure, wherein the depth of focus of the Raman microspectrometer is modulated at each site to generate a plurality of Raman spectra at different depths below the surface of the wafer at each site.

7. The method as set forth in claim 1 wherein the SiC polytype is determined by comparing the Raman spectra to a library of Raman spectra associated with SiC polytypes.

8. The method as set forth in claim 1 wherein the silicon-carbide structure is amorphous or a single crystal having a majority polytype, the majority polytype being 4H—SiC.

9. The method as set forth in claim 1 wherein the silicon-carbide structure is a silicon-carbide wafer, silicon-carbide wafer segment or epitaxial silicon-carbide wafer.

10. The method as set forth in claim 1 wherein the laser is an argon ion laser.

11. The method as set forth in claim 1 wherein the laser is operated at less than 50% of a maximum laser power.

12. The method as set forth in claim 1 wherein the laser is operated at less than 15% of a maximum laser power.
